(19) United States
(12) Patent Application Publication
(10) Pub. No.: US 2015/0272082 A1
(43) Pub. Date: Oct. 1, 2015

(54) AUTOMATIC CHICKEN COOP DOOR ATTACHMENT

(71) Applicant: Elam Miller, Willow Street, PA (US)

(72) Inventor: Elam Miller, Willow Street, PA (US)

(21) Appl. No.: 14/227,889

(22) Filed: Mar. 27, 2014

(51) Int. Cl. A01K 31/02; A01K 31/18

(52) U.S. Cl. CPC A01K 31/02; A01K 31/18

(57) ABSTRACT

An automatic chicken coop door attachment may include a shell having an interior housing, an exposed area having a first section and a second section, and at least one inner wall. A track may be attached along the at least one inner wall. A lip may be attached to the shell and positioned in front of an end of the track. The second section of the shell may expose a door opening. A door may slide along the track. A motor may be mounted within the interior housing of the shell. A wire may attach the door to the motor. The motor may move the door between an opened position and a closed position. A cover plate may cover the motor and the first section of the exposed area of the shell.

### BACKGROUND OF THE INVENTION

The present invention relates to chicken coops and, more particularly, to an automatic chicken coop door attachment.

Currently, every morning chickens need to be left out of the coop. In the evenings, the chickens need to be closed safely inside the coop to keep them from predators. Most chicken coops are made out of wood and/or materials that will decompose. These chicken coops do not have a door that runs on a track, nor do they have a door that is set to the time of the day you choose for it to open and close. These chicken coops rot, are not safe from predators and simply do not last for more than a year or two.

As can be seen, there is a need for an automatic chicken coop door attachment with a door that runs on a track.

### SUMMARY OF THE INVENTION

In one aspect of the present invention, a automatic chicken coop door attachment comprises: a shell having an interior housing, an exposed area having a first section and a second section, and at least one inner wall, wherein a track is attached along the at least one inner wall, wherein the second section comprises a door opening; a door that slides along the track; and a motor mounted within the interior housing of the shell, wherein a wire attaches the door to the motor, wherein the motor moves the door between an opened position and a closed position.

In another aspect of the present invention, a automatic chicken coop door attachment comprises: a shell having an interior housing, an exposed area having a first section and a second section, and at least one inner wall, wherein a track is attached along the at least one inner wall, wherein a lip is attached to the shell and positioned in front of an end of the track, wherein the second section comprises a door opening; a door that slides along the track; a motor mounted within the interior housing of the shell, wherein a wire attaches the door to the motor, wherein the motor moves the door between an opened position and a closed position; and a cover plate covering the motor and the first section of the exposed area of the shell.

In another aspect of the present invention, a method for keeping out predators comprises: attaching an automatic chicken coop door attachment onto a side of a chicken coop, wherein the automatic chicken coop door attachment is defined as a shell having an interior housing, an exposed area having a first section and a second section, and at least one inner wall, wherein a track is attached along the at least one inner wall, wherein the second section comprises a door opening; a door that slides along the track; a motor mounted within the interior housing of the shell, wherein a wire attaches the door to the motor, wherein the motor moves the door between an opened position and a closed position; and a cover plate covering the motor and the first section of the exposed area of the shell; and connecting the motor to a power source.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention in use;

FIG. 2 is a perspective view of an exemplary embodiment of the present invention;

FIG. 3 is an exploded view of an exemplary embodiment of the present invention;

FIG. 4 is a perspective view of an exemplary embodiment of the present invention with a door in the up position and intentionally omitting a cover plate for illustrative clarity;

FIG. 5 is a section view of an exemplary embodiment of the present invention along line 5-5 in FIG. 3 intentionally omitting a door track for illustrative clarity;

FIG. 6 is a section view of an exemplary embodiment of the present invention along line 6-6 in FIG. 4 intentionally omitting a door track for illustrative clarity; and

FIG. 7 is a section view of an exemplary embodiment of the present invention along line 7-7 in FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an automatic chicken coop door attachment that may include a shell having an interior housing, an exposed area having a first section and a second section, and at least one inner wall. A track may be attached along the at least one inner wall. A lip may be attached to the shell and positioned in front of an end of the track. The second section of the shell may expose a door opening. A door may slide along the track. A motor may be mounted within the interior housing of the shell. A wire may attach the door to the motor. The motor may move the door between an opened position and a closed position. A cover plate may cover the motor and the first section of the exposed area of the shell.

The present invention allows for the opening and closing of the chicken coop door without the person having to manually opening and close the chicken coop each morning and evening. The automatic chicken coop door attachment may allow a door to move vertically, horizontally, or the like along a track by a motor. A timer may also be used to make scheduled openings and closing.

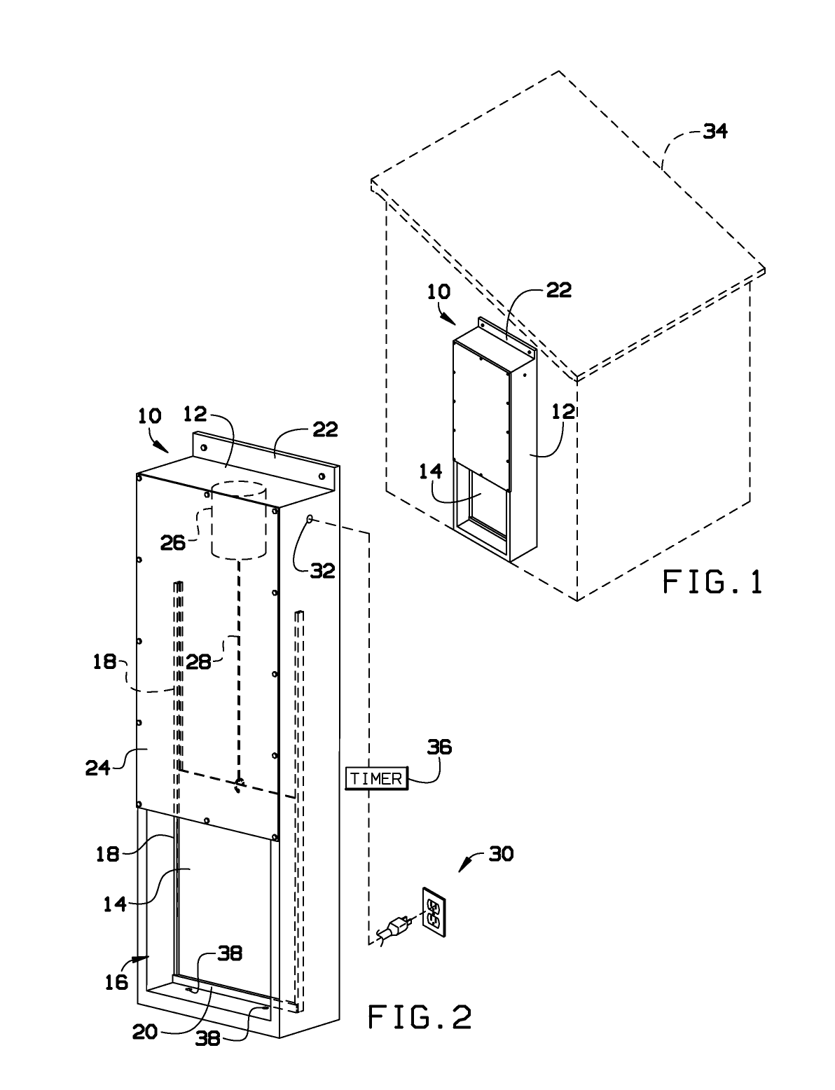

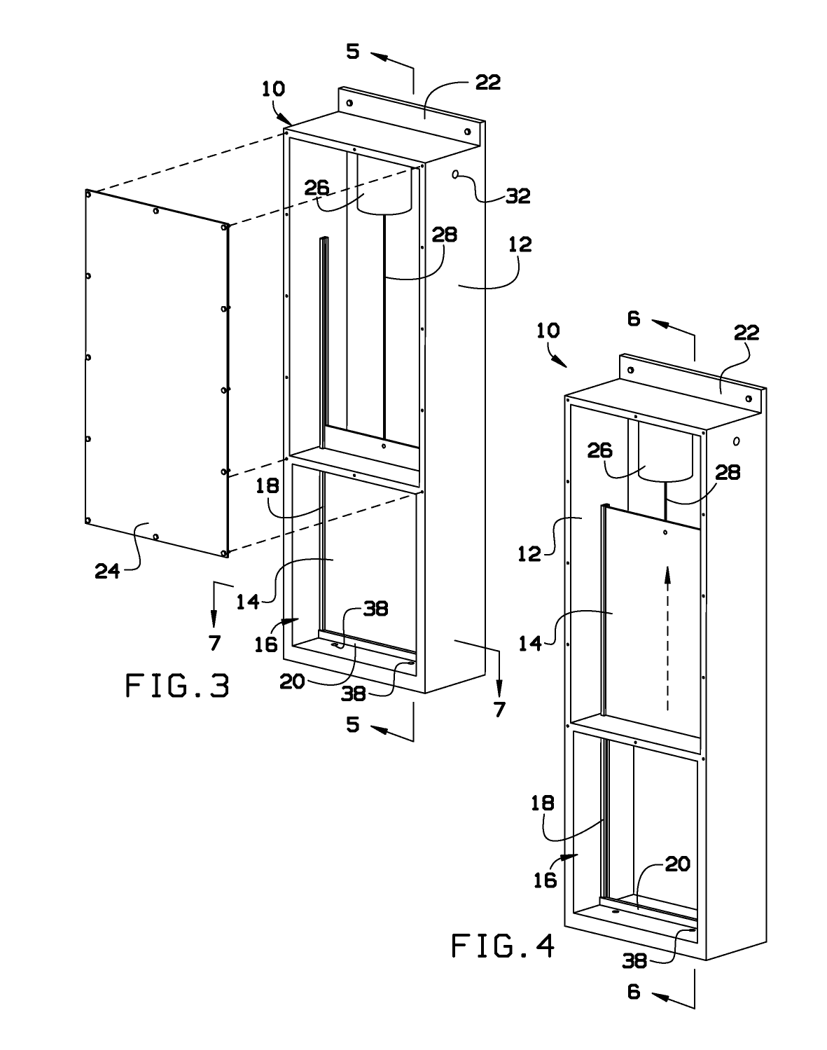

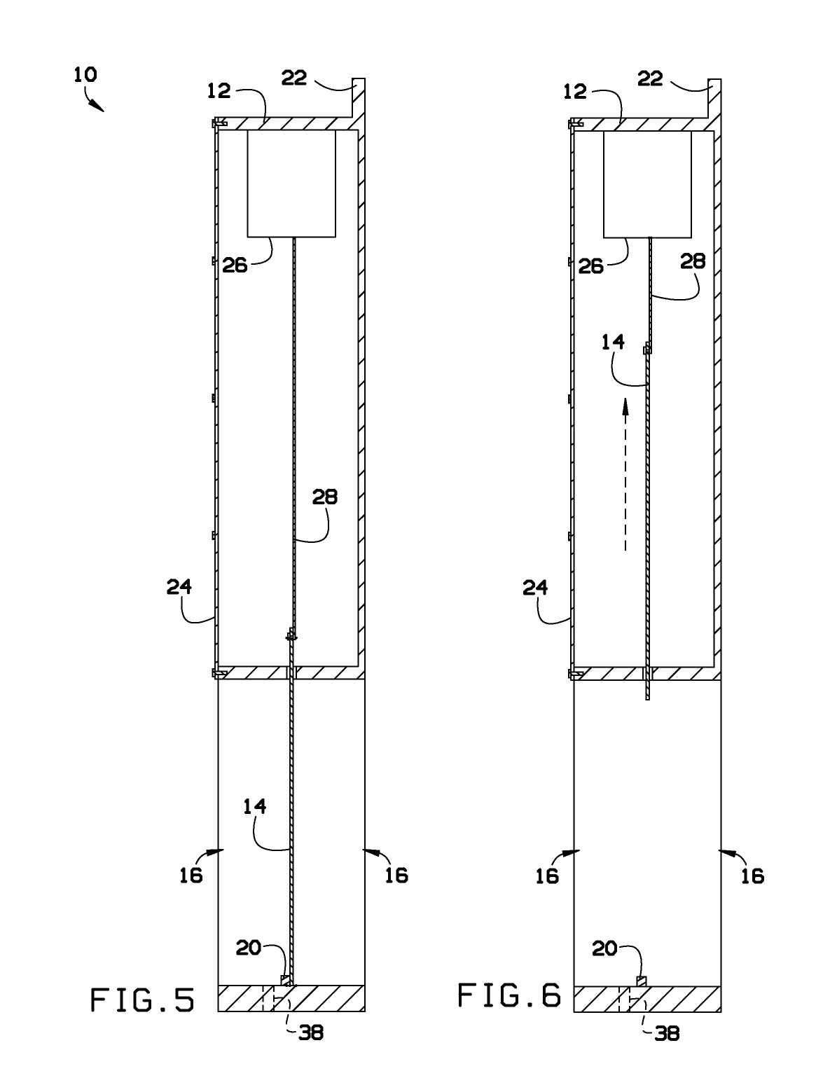

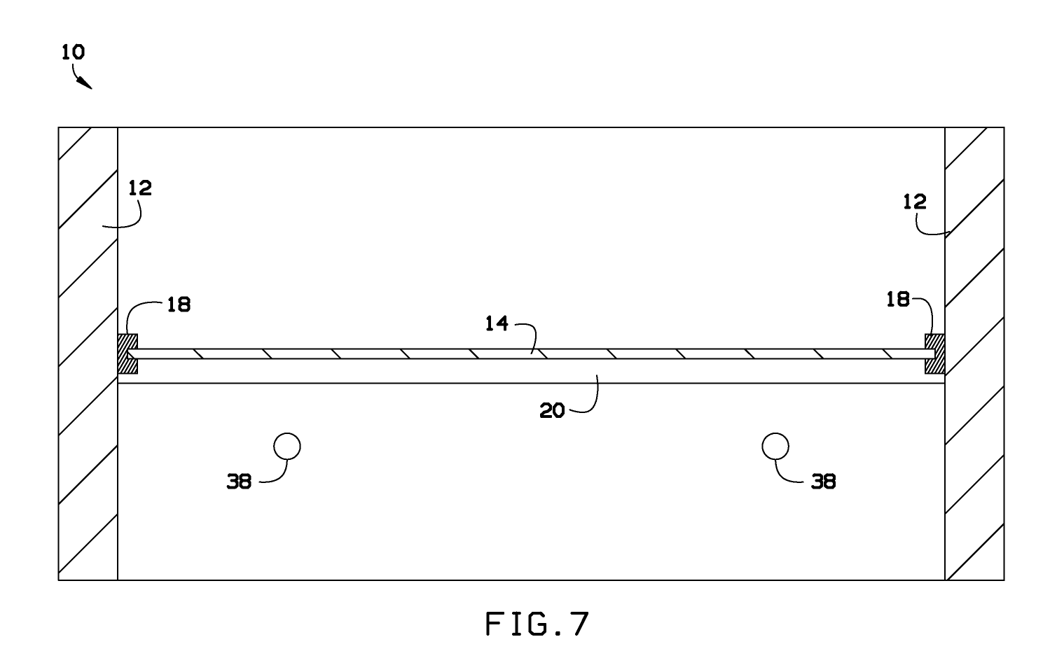

As is illustrated in FIGS. 1 through 7, the present invention 10 may include a shell 12 having an interior housing, at least one inner wall, and an exposed area. The shell 12 may hold most of the components within the interior housing of the shell 12. The shell 12 may be made from a poly board or similar material. A track 18 for a door 14 may be attached to at least one inner wall of the shell 12. The door 14 may slide along the track 18 from an open position to a closed position. A wire 28, string, or the like, may be attached to the door 14 as well as be attached to a motor 26. The door 14 may be made from aluminum or the like. The motor 26 may be attached for a power source 30. A hole 32 along a wall of the shell 12 may allow access for at least one electrical wire to be passed through to connect the motor 26 to the power source 30. The motor 26 may be covered from exposure by a cover plate 24. The cover plate 24 may cover a first section of the exposed area of the shell 12. The cover plate 24 may be made from aluminum or the like. A door opening 16 along a second section of the exposed area of the shell 12 may allow for entrance and exit through the door 14 when the door 14 may be in an opened position. In certain embodiments, the door opening 16 may expose a lip 20 along the end of the track 18 which may designate the end of the progression of the door 14. The lip 20 may also prevent predators from opening the door when it is in the closed position. In certain embodiments, a timer 36 may be connected to the motor 26 so that the opening and closing of the door 14 may be something that can be scheduled.

The automatic chicken coop door attachment 10 may be attached to a side of an exemplary chicken coop 34. A mounting bracket 22 may be attached to the shell 12. Mounting holes 38 may also be made along the shell 12. In certain embodiments the shell 12 may be made to be approximately 12 inches in width, approximately 6 inches in depth, and approximately 3 feet tall. A person may put the shell 12 together. The door 14 and the motor 26 may be inserted into the shell 12, where the motor 26 may be mounted. The cover plate 24 may then be placed over the first section of the shell 12 to enclose the motor 26. In certain embodiments, the motor 26 may be an 110V DC electrically powered motor 26. In certain embodiments, the timer 36 may be an 110V DC electrically powered timer 36.

It should be understood, of course, that the foregoing relates to exemplary embodiments of the invention and that modifications may be made without departing from the spirit and scope of the invention as set forth in the following claims.

What is claimed is:

1. An automatic chicken coop door attachment comprising:
a shell having an interior housing, an exposed area having a first section and a second section, and at least one inner wall, wherein a track is attached along the at least one inner wall, wherein the second section comprises a door opening;
a door that slides along the track; and
a motor mounted within the interior housing of the shell, wherein a wire attaches the door to the motor, wherein the motor moves the door between an opened position and a closed position.

2. The automatic chicken coop door attachment of claim 1, wherein the shell is made from a poly board.

3. The automatic chicken coop door attachment of claim 1, wherein the door is made from aluminum.

4. The automatic chicken coop door attachment of claim 1, further comprising a mounting bracket attached to the shell.

5. The automatic chicken coop door attachment of claim 1, further comprising a cover plate covering the motor and the first section of the exposed area of the shell.

6. The automatic chicken coop door attachment of claim 1, further comprising a timer, wherein the timer connects to the motor.

7. An automatic chicken coop door attachment comprising:
a shell having an interior housing, an exposed area having a first section and a second section, and at least one inner wall, wherein a track is attached along the at least one inner wall, wherein a lip is attached to the shell and positioned in front of an end of the track, wherein the second section comprises a door opening;
a door that slides along the track;
a motor mounted within the interior housing of the shell, wherein a wire attaches the door to the motor, wherein the motor moves the door between an opened position and a closed position; and
a cover plate covering the motor and the first section of the exposed area of the shell.

8. The automatic chick coop door attachment of claim 7, further comprising a timer, wherein the timer connects to the motor.

9. A method for keeping out predators comprising:
attaching an automatic chicken coop door attachment onto a side of a chicken coop, wherein the automatic chicken coop door attachment is defined as a shell having an interior housing, an exposed area having a first section and a second section, and at least one inner wall, wherein a track is attached along the at least one inner wall, wherein the second section comprises a door opening; a door that slides along the track; a motor mounted within the interior housing of the shell, wherein a wire attaches the door to the motor, wherein the motor moves the door between an opened position and a closed position; and a cover plate covering the motor and the first section of the exposed area of the shell; and
connecting the motor to a power source.

10. The method of claim 9, further comprising adding a hole along a wall of the shell that allows access for at least one electrical wire to be passed through to connect the motor to the power source.

11. The method of claim 9, further comprising the step of setting a timer, wherein the timer allows for the opening and closing of the door during a scheduled time.
